(19) United States
(12) Patent Application Publication
(10) Pub. No.: US 2008/0148967 A1
(43) Pub. Date: Jun. 26, 2008

(54) INKER STABILIZER

(76) Inventors: Shane M. POPOVICH, Batavia, IL (US); Joe Koch, Batavia, IL (US); Scott Neale, Batavia, IL (US)

Correspondence Address: MCGUIREWOODS, LLP, 1750 TYSONS BLVD, SUITE 1800, MCLEAN, VA, 22102, US

(21) Appl. No.: 11/766,601

(22) Filed: Jun. 21, 2007

Related U.S. Application Data
(60) Provisional application No. 60/815,269, filed on Jun. 21, 2006.

(51) Int. Cl. B41F 17/00

(52) U.S. Cl. 101/36

(57) ABSTRACT

A special article printing press includes a mandrel wheel for supporting an elongated article for printing thereon, a blanket cylinder for transferring ink onto the elongated article, a plate cylinder for selectively transferring ink to a section of the blanket cylinder, at least one inker for transferring ink onto a plate cylinder, a frame for holding the at least one inker, and an inker stabilizer configured to stabilize the inker or frame with respect to the plate cylinder, printing press, or blanket cylinder.

### CROSS-REFERENCE TO RELATED APPLICATIONS

This application claims priority under 35 U.S.C. §119(e) to provisional U.S. Patent Application No. 60/815,269, filed on Jun. 21, 2006, the disclosure of which is expressly incorporated by reference herein in its entirety.

### BACKGROUND OF THE INVENTION

1. Field of the Invention

The invention is directed to a device and method for printing on elongated articles with higher quality, and more particularly elongated articles that are cans.

2. Related Art

Many devices that print on elongated articles print with lower quality due to the elongated article's axial length and/or the limitations of the printer, more specifically, the printer will not fully print and will leave voids.

Accordingly, there is a need for a printer that can print on elongated articles with higher quality, and in particular, print having higher quality without voids.

### SUMMARY OF THE INVENTION

The invention meets the foregoing needs and allows for printing on elongated articles with higher quality print, and in particular, print without voids which results in significantly more attractive articles and other advantages of apparent from the discussion herein.

Accordingly, in one aspect of the invention a special article printing press configured to print on cylindrical objects includes a blanket cylinder for transferring ink onto an elongated article, a plate cylinder for selectively transferring ink to a section of the blanket cylinder, at least one inker for transferring ink onto a plate cylinder, a frame for holding the at least one inker, and an inker stabilizer configured to stabilize one of the inker and the frame with respect to at least one of the plate cylinder, printing press, and blanket cylinder in order to more uniformly decorate the cylindrical objects.

The inker may include an ink source and an ink train. The inker stabilizer may include mechanical fasteners that hold the inker stabilizer to the printing press. The inker stabilizer may be structured and arranged to connect to the inker on one end and connect to the plate cylinder on another end. The inker stabilizer may be arranged to stabilize one of the inker and the plate cylinder. The special article printing press may include a mandrel wheel for supporting the elongated article for printing thereon.

According to another aspect of the invention a special article printing press includes a blanket cylinder for transferring ink onto an elongated article, a plate cylinder for selectively transferring ink to a section of the blanket cylinder, at least one inker for transferring ink onto a plate cylinder, a frame for holding the at least one inker, and an inker stabilizer configured to stabilize one of the inker and the frame with respect to at least one of the plate cylinder, printing press, and blanket cylinder.

The inker may include an ink source and an ink train. The inker stabilizer may include mechanical fasteners that hold the inker stabilizer to the printing press. The inker stabilizer may be structured and arranged to connect to the inker on one end and connect to the plate cylinder on another end. The inker stabilizer may be arranged to stabilize one of the inker and the plate cylinder. The special article printing press may include a mandrel wheel for supporting the elongated article for printing thereon.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a printing press that may be configured to use the invention;

FIG. 2 shows the specific detail of the inker of the printing press of FIG. 1;

FIG. 3 shows an elongated article, such as a can, decorated in a printing press implemented without the invention and with the invention;

FIG. 4 shows an inker stabilizer constructed according to the principles of the invention and arranged in a printing press similar to the printing press of FIG. 1; and

FIGS. 5, 6, 7, and 8 shows different views of the inker stabilizer constructed according to the principles of the invention for use in the printing press shown in FIG. 1 or 4.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

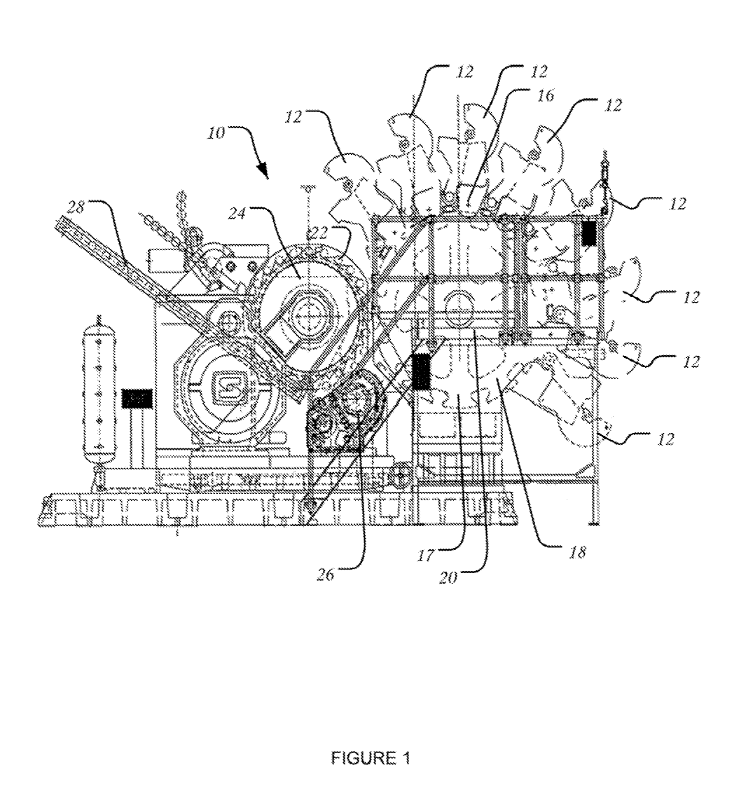

FIG. 1 shows a printing press that may be configured to use the invention. In particular, FIG. 1 shows a printer 10 that prints on elongated articles 22 such as cans. In this case, the elongated articles 22 may be fed to the printer 10 via a conveyor which is known in the art. The conveyor may place the elongated articles 22 on a mandrel wheel 24 for printing or decorating. The mandrel wheel 24 may carry the elongated articles 22 around to a position where they may be engaged with an inking blanket 18. The inking blanket 18 may transfer ink onto a surface of the elongated article 22 decorating the same. The inking blanket 18 may be mounted on a wheel 20. The elongated article 22 may then be removed from the mandrel wheel 24 and may be removed and sent to an over-varnishing unit 26 where varnish is coated thereon. Thereafter, the elongated article 22 may move through a curing process such as on a chain conveyor 28 going to and from an oven.

The inking blanket 18 may receive multiple color inks to be transferred to the can on the mandrel wheel 24 from a number of inkers 12 attached to the printer at 16. Each inker 12 may provide one color to the inking blanket 18 to provide a multi-color ink image for transfer to the elongated article 22. In particular, the inking blanket 18 may have a plurality of sections 17. Each section 17 may be sized to transfer an entire elongated article 22 worth of ink to the elongated article 22 as the elongated article 22 is rotated on the mandrel wheel 24.

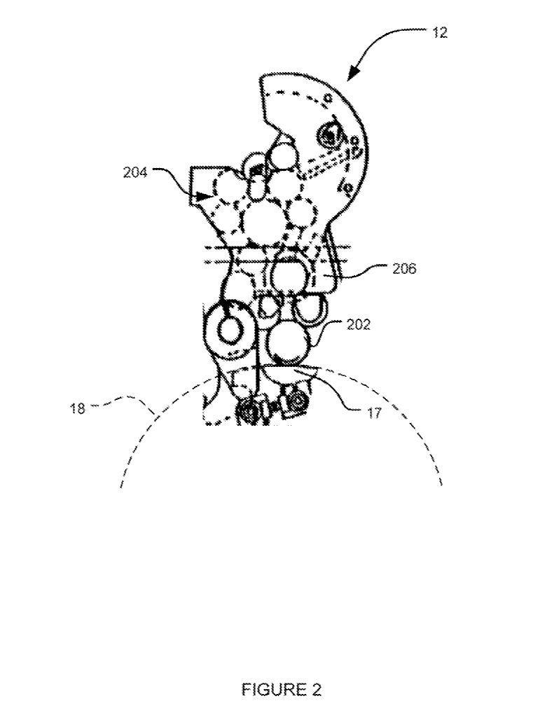

FIG. 2 shows specific detail of one of the inkers 12 of the printer 10 of FIG. 1. More specifically, FIG. 2 shows the inker 12 and its arrangement with the blanket cylinder 18 (partially shown). The inker 12, as shown in FIG. 2, further includes a plate cylinder 202 that transfers the ink from the inker 12 onto one of the sections 17 (only one shown) of the inking blanket 18. Moreover, the inker 12 further may include various cylinders to form an ink train and various other components as generally indicated by reference number 204 as is known in the art. Thus, numerous components of the inker 12 may be held by a frame 206. The frame 206 has a tendency to move during a printing process. More specifically, the inker 12 and the various components held by frame 206 rotate at a high speed and have a tendency to vibrate or shake. The unstable nature of the inker 12 causes a problem with the plate cylinder 202 transferring ink from the inker 12 to the sections 17 of the inking blanket 18 and generates sub-quality printing such as voids in the print on the elongated article 22. This problem becomes more significant with longer articles.

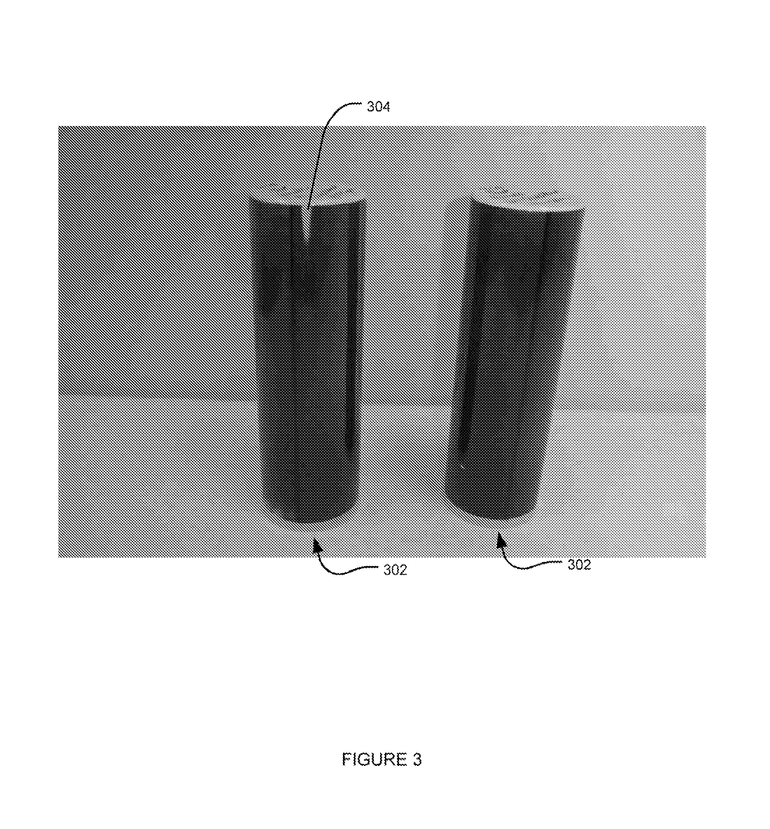

FIG. 3 shows two cans that have been decorated using a can decorating printer such as that shown in FIG. 1. In particular, the can on the left shows a void 304 that is created when the inker 12 it is allowed to vibrate or shake. The can 302 on the right has been printed by printer such as the printer in FIG. 1 with the addition of an inker that includes a stabilizer. In particular, note that the can on the right 302 does not have any sort of printing voids 304 such as shown on the can on the left.

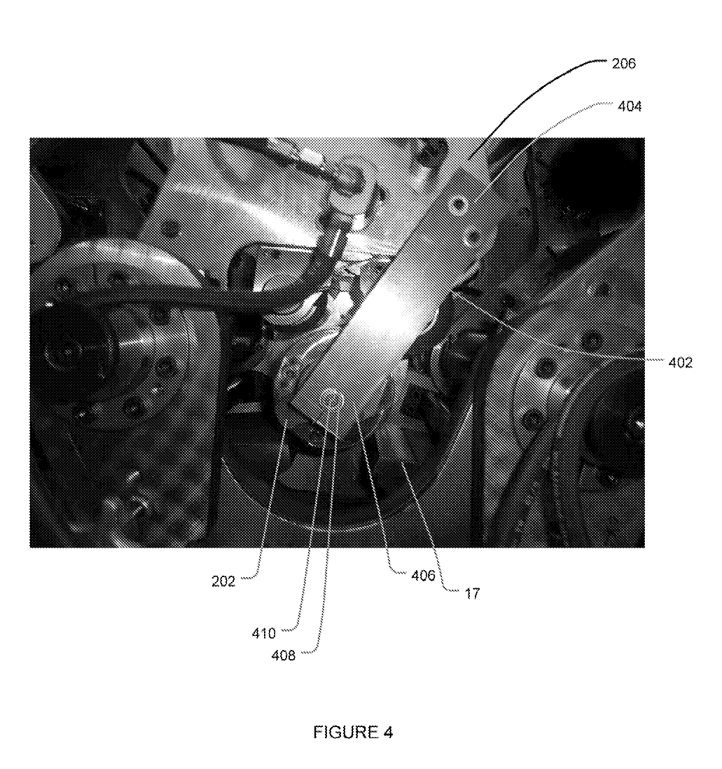

FIG. 4 shows a close-up photograph of the inker 12, and in particular, the inker frame 206, the plate cylinder 202, and a section 17 of the blanket cylinder 18. Additionally, FIG. 4 shows an inker stabilizer 402. The inker stabilizer 402 may be formed of a plate or bracket that may be connected to the inker stabilizer 402 at a first end 404 to the inker 12 such as to the frame 206. The stabilizer 402 may also be connected to the plate cylinder 202 at another end 406 to a bearing 408 supported on a shaft 410 of the plate cylinder 202. Accordingly, the stabilizer 402 is able to maintain or stabilize the inker 12 with respect to the plate cylinder 202 and the various sections 17 of the blanket cylinder 18. With stabilization lower quality printing, such as voids in the printing shown in FIG. 3 are reduced and possibly eliminated. The inker stabilizer 402 may be further to be easily removed and attached to the printer 10 to allow for repair of printer components, replacement of printing plates and so on. It should be further noted that any positioning of an inker stabilizer and any particular attachment points is within the spirit and scope of the invention.

It is noted however that although a particular embodiment of the inker stabilizer 402 is shown. Any known type of stabilizing structure is contemplated with the invention. In particular, any type of structure that may maintain a proper distance between the inker 12, the plate cylinder 202, and the sections 17 of the blanket cylinder 18 is contemplated by the invention herein. Moreover any type of structure that reduces or eliminates vibration of the plate cylinder 202 is further contemplated by the invention.

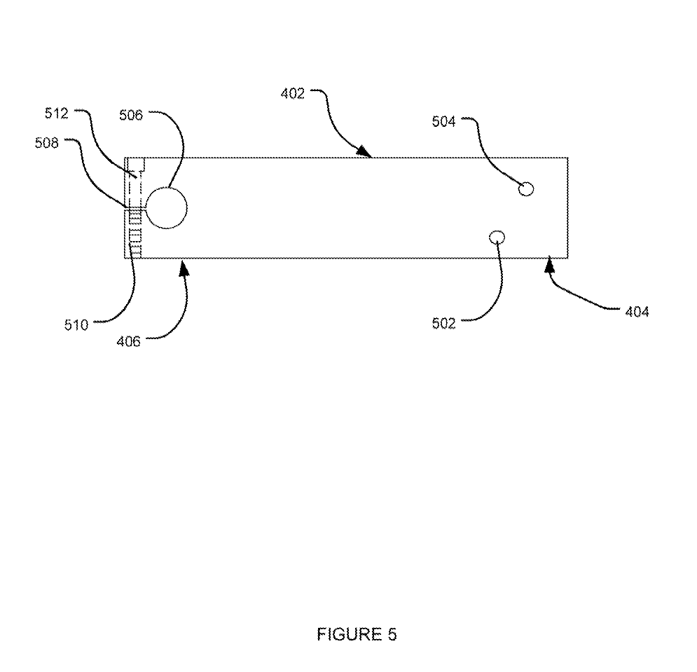

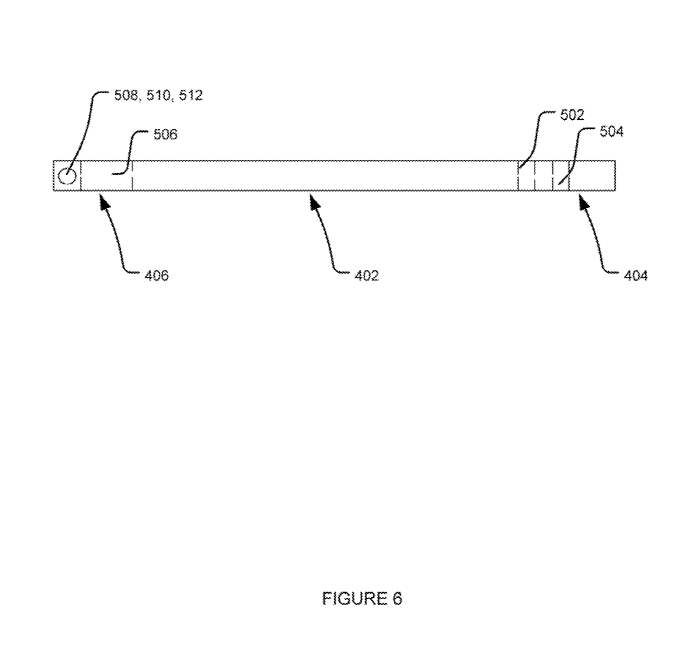

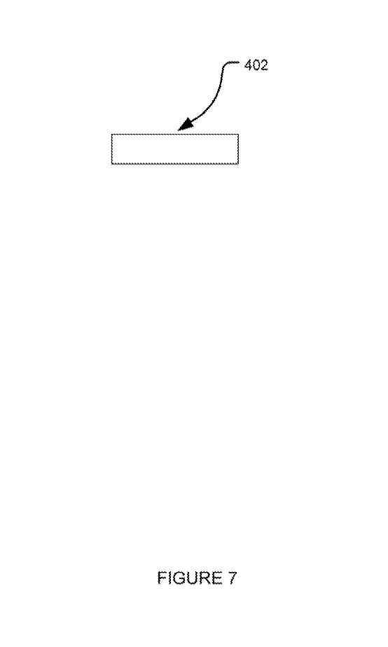

FIGS. 5, 6, 7, and 8 show an exemplary embodiment of the inker stabilizer 402. In particular, as shown FIG. 5 is a top review, FIG. 6 is a side view, and FIG. 7 is an end view. As further shown in FIGS. 5, 6, and 7, the inker stabilizer 402 may have a first end 404 that is connectable to the frame 206 of the inker 12 or the like. In particular, the stabilizer 402 first end 404 may be connected to the inker 12 via two apertures 502, 504. The apertures 502, 504 may receive a bolt or other type of known mechanical fastener therethrough for connection of the first end 404 of the inker stabilizer 402 for connection to the frame 206 of the inker 12. The other end 406 of the inker stabilizer 402 may also have an aperture 506 for receiving a shaft which is connected to the plate cylinder 202. The inker stabilizer 402 may further include a slot 508 that may be arranged at the other end 406 of the inker stabilizer 402. The slot 508 may provide a way in which the size of the aperture 506 may be expanded or reduced. Moreover, the inker stabilizer 402 may include an aperture 510 that may be capable of receiving a bolt 512. The aperture 510, bolt 512 and slot 508 work in combination to reduce a diameter of the aperture 506 to tightly hold onto the bearing 408. Moreover, the aperture 510 may be threaded such that the bolt 512 may threadingly engage in the aperture 510.

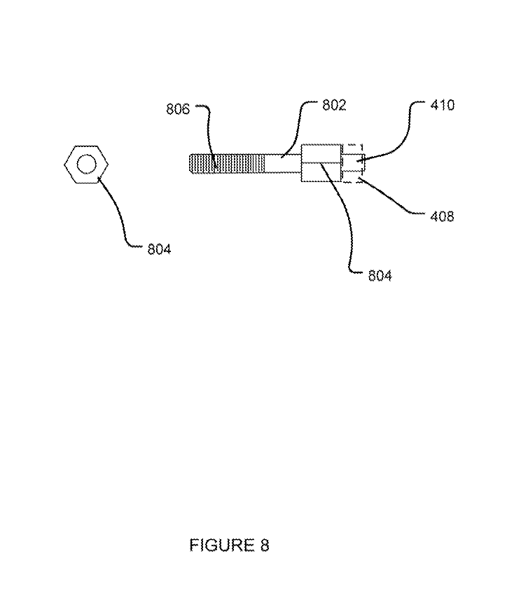

FIG. 8 shows an exemplary implementation of the shaft 410 and bearing 408. In this implementation, the shaft 410 may be formed at an end of a head 804 of a bolt 802 that may be inserted into the plate cylinder 202. The bolt 802 may include threads 806 along with the head 804 to mechanically fasten the bolt 802 into a threaded bore (not shown) in the plate cylinder 202. Other types of known fasteners are also within the spirit and scope of the invention.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A special article printing press configured to print on cylindrical objects comprising:
a blanket cylinder for transferring ink onto an elongated article;
a plate cylinder for selectively transferring ink to a section of the blanket cylinder;
at least one inker for transferring ink onto a plate cylinder;
a frame for holding the at least one inker; and
an inker stabilizer configured to stabilize one of the inker and the frame with respect to at least one of the plate cylinder, printing press, and blanket cylinder in order to more uniformly decorate the cylindrical objects.

2. The special article printing press according to claim 1 wherein the inker comprises an ink source and an ink train.

3. The special article printing press according to claim 1 wherein the inker stabilizer includes mechanical fasteners that hold the inker stabilizer to the printing press.

4. The special article printing press according to claim 1 wherein the inker stabilizer is structured and arranged to connect to the inker on one end and connect to the plate cylinder on another end.

5. The special article printing press according to claim 1 wherein the inker stabilizer is arranged to stabilize one of the inker and the plate cylinder.

6. The special article printing press according to claim 1 further comprising a mandrel wheel for supporting the elongated article for printing thereon.

7. A special article printing press comprising:
a blanket cylinder for transferring ink onto an elongated article;
a plate cylinder for selectively transferring ink to a section of the blanket cylinder;
at least one inker for transferring ink onto a plate cylinder;
a frame for holding the at least one inker; and
an inker stabilizer configured to stabilize one of the inker and the frame with respect to at least one of the plate cylinder, printing press, and blanket cylinder.

8. The special article printing press according to claim 7 wherein the inker comprises an ink source and an ink train.

9. The special article printing press according to claim 7 wherein the inker stabilizer includes mechanical fasteners that hold the inker stabilizer to the printing press.

10. The special article printing press according to claim 7 wherein the inker stabilizer is structured and arranged to connect to the inker on one end and connect to the plate cylinder on another end.

11. The special article printing press according to claim 7 wherein the inker stabilizer is arranged to stabilize one of the inker and the plate cylinder.

12. The special article printing press according to claim 7 further comprising a mandrel wheel for supporting the elongated article for printing thereon.
